(19) United States
(12) Patent Application Publication
(10) Pub. No.: US 2025/0189994 A1
(43) Pub. Date: Jun. 12, 2025

(54) METHODS AND SYSTEMS FOR REMOTE OPERATION OF VEHICLE

(71) Applicant: Rotor Technologies, Inc., Cambridge, MA (US)

(72) Inventors: Kristoffer Martin FREY, Cambridge, MA (US); Devansh Ramgopal AGRAWAL, Ann Arbor, MI (US)

(21) Appl. No.: 19/038,117

(22) Filed: Jan. 27, 2025

Related U.S. Application Data
(63) Continuation of application No. PCT/US2023/074476, filed on Sep. 18, 2023.
(60) Provisional application No. 63/409,494, filed on Sep. 23, 2022.

(51) Int. Cl. G05D 1/87; G05D 1/222; G05D 1/227; G05D 109/25

(52) U.S. Cl. CPC G05D 1/87; G05D 1/222; G05D 1/2274; G05D 2109/25

(57) ABSTRACT

The present invention provides methods and systems for remote operation of a vehicle with the capability to deal with communications jitter and intermittency. In particular, the methods and systems herein may safely predict a remote operator's intent (e.g., remote pilot) over long time scales, and up to the lost link timeout T_{LL}.

### CROSS-REFERENCE TO RELATED APPLICATIONS

This application is a continuation of International Application No. PCT/US2023/074476, filed Sep. 18, 2023, which claims the priority and benefit of U.S. Provisional Application No. 63/409,494, filed on Sep. 23, 2022, each of which are incorporated herein by reference in their entirety for all purposes.

### BACKGROUND

Remote operation (also known as tele-operation) of a vehicle can achieve many of the scalability, cost, and safety benefits of autonomy while maintaining the operating flexibility of human-in-the-loop control. Remote operation has various applications such as in construction, industrial inspection, and transportation. Recent developments in cellular communications, low-orbit satellite Internet, and Internet of Things present significant opportunities for remote operation at finer control granularities and over larger distances than previously imagined.

However, the spatial separation of operator and machine, potentially at global scales, places significant reliability requirements on the underlying communication link, which may be achieved by a fully-wired or, most often, wireless link. In practice, these links often comprise line-of-sight radio communications, cellular networks, or satellite communications, and may include traversals through large networks or even across the open Internet. In almost all cases, ensuring delivery of every data packet in a timely fashion is impossible, presenting a significant challenge for safe and efficient remote operation of dynamically-unstable vehicles like cars, construction vehicles, and aircraft.

### SUMMARY

In some cases, complete loss of communications (wireless) between operator and vehicle can happen. System designers are required to define a form of “lost link” protocol, in which the vehicle guides itself autonomously into a safe recovery state. For a car driving in traffic, this protocol may include, for example, slowing down and pulling to the side of the road safely. For an aerial vehicle, the protocol may include entering a hover or holding pattern until link is re-established, or attempting an autonomous landing. The autonomous mode may be entered upon a discrete, logical “switch” triggered by a timeout threshold T_{LL} (Lost Link Timeout).

However, the lost-link protocol often introduces significant complexity in the overall system design. Depending on safety, risk, and environmental considerations, the lost link protocol itself can represent a nontrivial degree of autonomy. This is complicated by the fact that a link may be lost at any instant, in any operating condition, and thus the protocol is expected to be able to recover control safely in all conditions. The conditions under which the implemented lost link protocol may safely recover the vehicle often define or restrict the allowable normal operating conditions. For instance, if the lost-link timeout threshold T_{LL} is set as too long, the vehicle may enter an irrecoverable state well before the lost link protocol takes over. If the lost-link timeout threshold T_{LL} is set too short, it may trigger the autonomous mode due to relatively benign jitter and packet drops that invariably occur over complicated networks, even under nominal conditions. Such “false” lost link triggers can represent frustrating interruptions in the tele-operation experience, and may impede mission effectiveness or even introduce safety risks of their own.

In addition to the change of selecting suitable lost link protocol and timeout threshold, there are other challenges. Particularly, it can be challenging to determine what the remote vehicle should do when the input is “stale” but before the link is fully considered lost (i.e., when less than T_{LL} time has elapsed since the latest command packet). Conventionally, a vehicle control system may just continue to use the latest received input (often referred to as a “zero-order hold”), but this may not be appropriate for vehicles with unstable dynamics operating in fast-changing environments. Alternatively, a system designer may have to choose a very short timeout threshold (small T_{LL}) which may lead to frequent initiations of the lost-link protocol for communication links with significant jitter (e.g., those traversing switched public networks like the Internet).

A need exists for an improved system of vehicle remote control, and particularly a system capable to address “stale” command data. The present disclosure provides improved methods and systems for remote operation of a vehicle with the capability to handle communications jitter and intermittency with improved safety. In particular, the methods and systems herein may safely predict a remote operator's intent (e.g., remote pilot) over relatively long-time scales up to the lost link timeout T_{LL}. The estimated operator intent may be utilized by the remote system to smoothly navigate short-duration dropouts with improved pilot experience and system performance. Methods and systems of the present disclosure beneficially ensure a seamless transition between tele-operation and lost-link autonomy as a short-term link dropout becomes an official “lost link,” and furthermore can allow for further increasing the threshold T_{LL}.

In an aspect of the present disclosure, a method for predicting an operator's intent (e.g., remote pilot) over long time scales is provided. The method may comprise: (a) predicting an operator's intent over a short horizon based on input device position data, where the operator's intent over the short horizon is predicted by performing a numeric fit to K number of input device position data samples; (b) generating a long-horizon prediction based at least in part on the operator's intent predicted in (a) and real-time sensor data.

In another aspect of the present disclosure, a method for predicting an operator's intent for controlling a remote vehicle is provided. The method comprises: (a) predicting a first intent over a short horizon based on an input device position data, wherein the first intent is predicted by performing a numeric fit to K number of input device position data samples and where the K number of input device position data samples are collected from an input control device for controlling the remote vehicle; (b) predicting a second intent over a long horizon based at least in part on the first intent predicted in (a) and real-time sensor data, where the real-time sensor data are collected from one or more sensors onboard the remote vehicle; and (c) generating a control signal for controlling one or more actuators of the remote vehicle based on the second intent.

In some embodiments, operation (a) is performed by one or more processors located at a remote control station. In some embodiments, the first intent comprises a numerically-fit trajectory of the input device position data. In some cases, method further comprises transmitting the numerically-fit trajectory of the input device position data to the remote vehicle via a wireless link. In some instances, a regression model for performing the numeric fit is selected based at least in part on a bandwidth of the wireless link.

In some embodiments, operation (b) is performed by one or more processors onboard the remote vehicle. In some embodiments, the second intent is further predicted based on a dynamic model of the remote vehicle. In some embodiments, the real-time sensor data are used for hazard avoidance. In some embodiments, the second intent is predicted using an explicit optimization-based algorithm. In some cases, the second intent is further predicted based on a predefined safety objective of the remote vehicle. In some cases, the predefined safety objective of the remote vehicle is represented by a deviation between a current state and a reference state. In some instances, the current state is measured by the real-time sensor data. For example, the explicit optimization-based algorithm comprises a blending time constant for blending the first intent with the predefined safety objective.

In some embodiments, the second intent comprises a long-horizon input trajectory and the control signal is generated based on the long-horizon input trajectory. In some cases, the long-horizon input trajectory is executed by a controller onboard the remote vehicle by synchronizing a clock of the remote vehicle and a clock at the input control device.

In a related yet separate aspect, a system is provided for predicting an operator's intent for controlling a remote vehicle. The system comprises: (a) a first processor programmed to predict a first intent over a short horizon based on an input device position data, where the input device position data are collected from an input control device for controlling the remote vehicle and where the first processor is located at a control station; (b) a second processor programmed to i) predict a second intent over a long horizon based at least in part on the first intent and real-time sensor data, and ii) generate a control signal for controlling one or more actuators of the remote vehicle based on the second intent, where the real-time sensor data are collected from one or more sensors onboard the remote vehicle and where the second progressor is located at the remote vehicle.

In some embodiments, the first intent is predicted by performing a numeric fit to K number of input device position data samples. In some cases, the first intent comprises a numerically-fit trajectory of the input device position data. In some cases, a regression model for performing the numeric fit is selected based at least in part on a bandwidth of a wireless link between the control station and the remote vehicle.

In some embodiments, the second intent is further predicted based on a dynamic model of the remote vehicle. In some embodiments, the second intent is predicted using an explicit optimization-based algorithm. In some cases, the second intent is further predicted based on a predefined safety objective of the remote vehicle. In some instances, the predefined safety objective of the remote vehicle is represented by a deviation between a current state and a reference state. For example, the current state is measured by the real-time sensor data. In some instances, the explicit optimization-based algorithm comprises a blending time constant for blending the first intent with the predefined safety objective.

In some embodiments, the second intent comprises a long-horizon input trajectory and the control signal is generated based on the long-horizon input trajectory. In some cases, the second processor is further programmed to synchronize a clock of the remote vehicle and a clock at the input control device to generate the control signal.

Additional aspects and advantages of the present disclosure will become readily apparent to those skilled in this art from the following detailed description, wherein only exemplary embodiments of the present disclosure are shown and described, simply by way of illustration of the best mode contemplated for carrying out the present disclosure. As will be realized, the present disclosure may be capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 shows an example of the remote operation method implemented in a helicopter-based aerial work application.

FIG. 2 shows an example distribution of packet latencies.

FIG. 3 shows intent prediction of an operator illustrated as extrapolation.

FIG. 4 shows a system implementing the remote control methods consistent with those described herein.

FIG. 5 shows examples of aircraft controlled by the methods and systems herein.

### DETAILED DESCRIPTION

The present disclosure provides systems and methods for remote control of movable objects (e.g., vehicles). Systems and methods herein may beneficially ensure a seamless transition between tele-operation and lost-link autonomy as a short-term link dropout becomes an official “lost link,” and can allow for further increasing the threshold T_{LL} to avoid “false” lost link triggers.

In an aspect, the present disclosure provides an algorithm for extrapolating instantaneous operator input (i.e., stick and rudder inputs) into an inferred target policy that naturally enforces safety constraints (e.g., stability, hazard avoidance) over time horizons (periods of time). The time horizons may be multiple times longer than the baseline communication latency (up to multiple seconds). In particular, the algorithm may produce a short-horizon (short period of time) prediction of pilot intention. For instance, the algorithm may use numeric functional approximation (e.g., polynomial, rational, or Fourier basis) to generate the short-horizon prediction of operator's intention. The operator's intent may be predicted over the upcoming short-horizon of for example, 10-100 ms. The algorithm may then produce a long-horizon (long period of time) prediction by fusing this short-horizon prediction (in input space) with a pre-defined “safe state” objective (in state space) via an optimal control. For instance, the operator's intent over an upcoming long-horizon of up to the full timeout threshold T_{LL} (e.g., 50 ms-2 s) may be predicted by the algorithm. Depending on the specific application, the long horizon may be below 50 ms or greater than 2 s.

The long-horizon (long period of time) prediction may incorporate any suitable state-space objectives. A state-space objective may include, for example, enforcing a suggested or nominal movement speed or direction, or an objective term that encourages the vehicle to come to a stopped or hover position by the end of the horizon, or hazardous avoidance objective. In some cases, one or more of the state-space objectives may be combined into a single objective. A safe state may be defined in a state space of the vehicle. For instance, depending on the vehicle type, a state space refers to the n-dimensional space of vehicle states including position, velocity, and orientation. A pre-defined “safe state” objective may be based on the type of vehicle or navigation mode. In an example of air vehicle, pilot inputs may include desired angular rates, and the prescribed “safe state” may include “straight-and-level” flight. In an example of land vehicle, the inputs may include steering angle, brake, and throttle, and the “safe state” may include cruise speed in the center of the lane.

In some cases, the optimal control method herein may determine a starting point based on a vehicle current state, a past state corresponding to where the vehicle was when the input was given on the ground station, or the state estimate that was presented to a remote operator at the time of input.

The algorithm may generate a long-horizon prediction based at least in part on real-time sensor data, a state-space objective such as hazard avoidance objectives and the short-horizon prediction. This beneficially rejects unsafe inputs from the operator and protects the system against accidents. The short-horizon prediction and long-horizon prediction may be computed on the operator side (e.g., ground station), on the remote vehicle side or a combination of both. In some embodiments, the short-horizon prediction may be performed by the computer system at the ground station thereby leveraging high-rate sampling of control inputs received at the ground station, and the long-horizon prediction may be performed by a processor onboard the vehicle leveraging the instant access to full sensor data local to the vehicle.

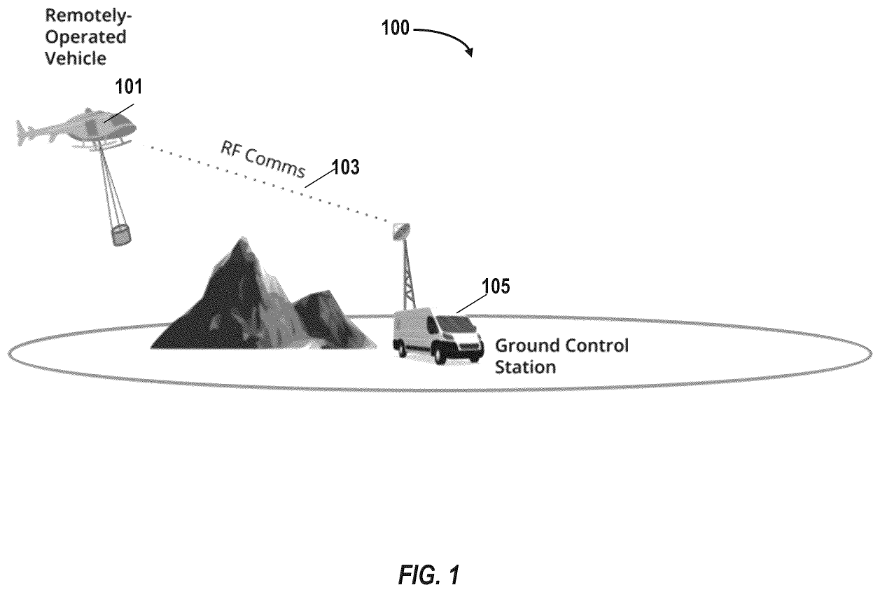

FIG. 1 shows an example of the remote operation method implemented in a helicopter-based aerial work application. The operator and an input device (e.g., input inceptors) may be located at a control station 105. The control station may be located separately and remotely from the vehicle (e.g., helicopter) 101. Communications 103 between the operator and the helicopter may be achieved by wireless links such as any combination of direct radio links, cellular networks, and satellite-based radio links.

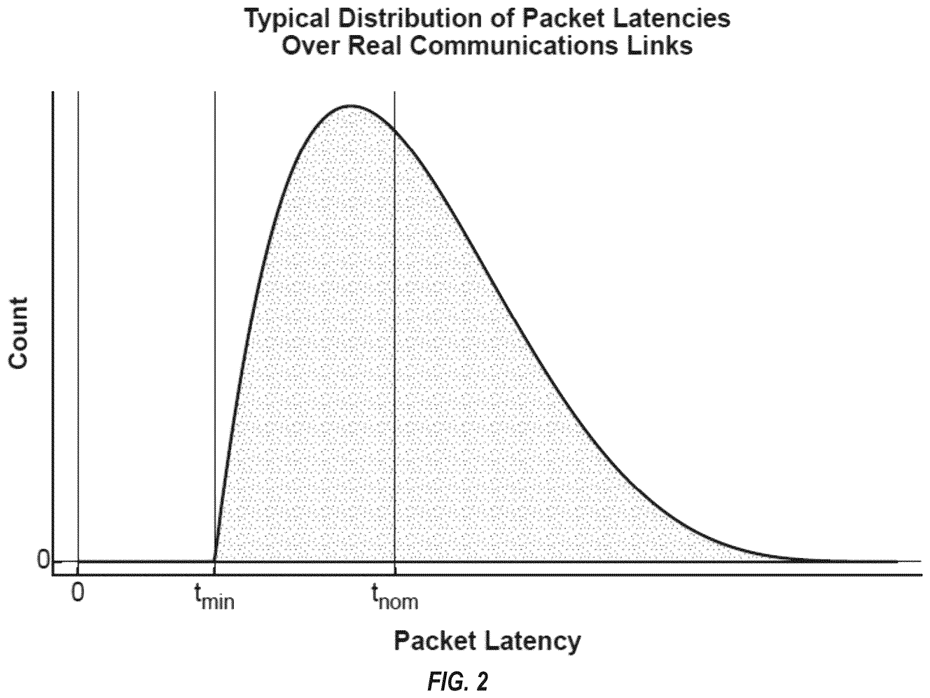

FIG. 2 shows an example distribution of packet latencies. Even under nominal conditions, packet latency (i.e., delivery time) can be unpredictable, particularly over complex public networks such as the Internet. Communications links are typically characterized by a non-zero, nominal latency (often a minimum or median of the distribution) around which most of the distribution is concentrated. In tele-operations applications, the lost-link timeout threshold T_{LL} is usually chosen to lie beyond the “normal” range of variation.

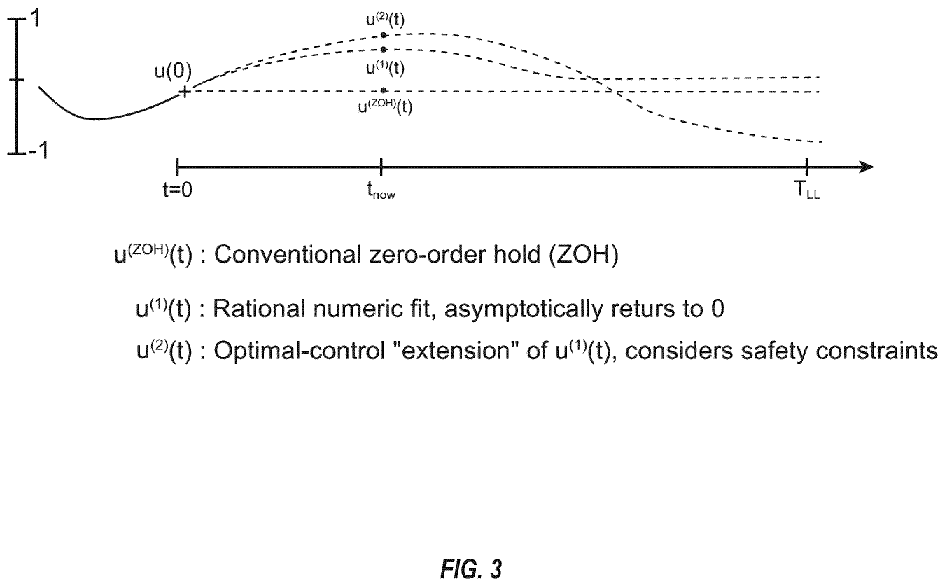

FIG. 3 shows intent prediction of an operator illustrated as extrapolation. The intent prediction algorithm described herein has improved performance compared to conventional zero-order-hold techniques or purely numeric functional method. Conventional zero-order-hold techniques can deviate from true intention dramatically. For instance, conventional zero-order-hold technique may employ purely numeric functional approximation method which can more smoothly continue prior trends in pilot input, but cannot ensure safety. The present intent prediction algorithm herein may address the above drawbacks of the conventional method by employing a model-predictive extrapolation method which extends the numeric approximation by taking into account the vehicle dynamics, safety, stability, and mission considerations to better match the operator's true intent.

In some cases, the model-predictive method herein may be capable of accurately and safely predict pilot intention over a long-time horizon (e.g., a long-horizon of up to 1 second, 2 seconds, 3 seconds, etc.). The model-predictive method herein combines standard numeric functional approximation of the pilot input channels with task- and vehicle-specific safety objectives in an optimal control framework. In some embodiments, the method may comprise a combination of numeric functional approximation and explicit, model-based optimal control.

In some cases, multiple operations of the method may be performed by one or more processors located at the remote vehicle and the control station to be close to the real-time data. For example, a first operation relying on operator input may be implemented by one or more processors at a control station computer (CSC), and a second operation relying on real-time sensor may be implemented by one or more processors onboard the remote vehicle computer (RVC).

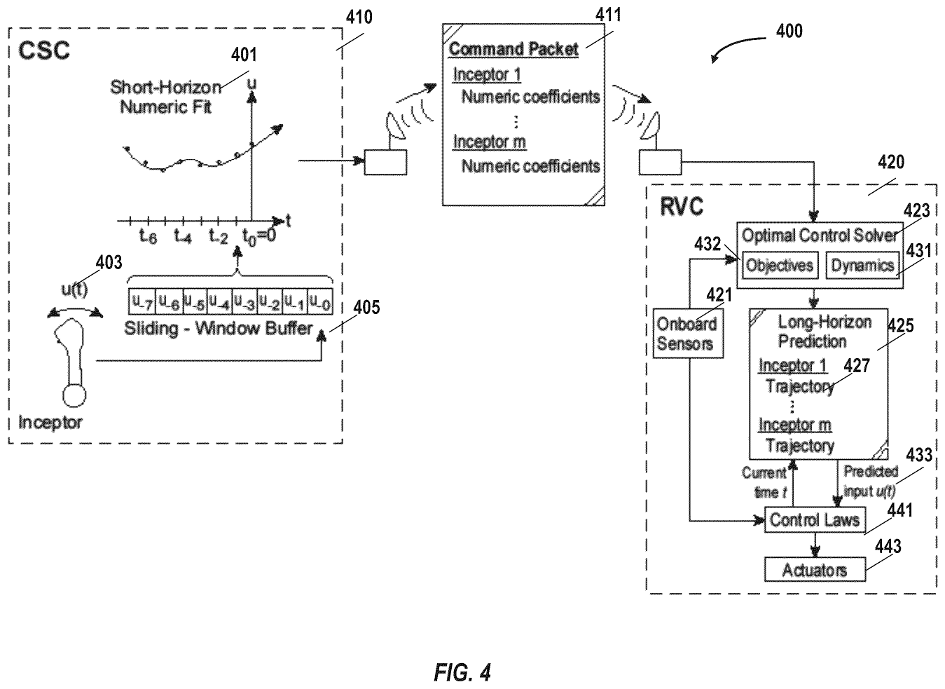

FIG. 4 shows an exemplary system implementing a remote control method 400 consistent with those described herein. In some embodiments, the method 400 may comprise two stages including a first stage prediction 410 implemented at the CSC and a second stage prediction 420 implemented at the RVC. In some cases, the first stage prediction 410 may include a short-horizon prediction. As shown in the example, the CSC may sample inceptor position u(t) 403 at a high rate, populating a sliding-window buffer 405. The inceptor position may be sampled for each input channel. The inceptor position data such as the data in the sliding-window buffer may be used to perform a short-horizon functional approximation 401. In some cases, the short-horizon functional approximation may utilize short-horizon numeric fitting. The output of the short-horizon functional approximation may comprise coefficients of the numeric fitting along with inceptor data which are sent over the communications link to the remote vehicle computer (RVC) for performing the second stage prediction 420.

The RVC may combine the short-horizon input trajectory with onboard sensor data via a Model-Predictive Optimal Control solver 423 to produce a long-horizon input trajectory prediction 425 capturing an implied pilot intent. Details about the short-horizon functional approximation using numeric fit, long-horizon prediction algorithm and the Model-Predictive Optimal Control are described later herein.

### Short-Horizon Functional Approximation

In some cases, within the control station, the position of the pilot control inceptors (e.g., pilot controls on fixed- and rotary-wing platforms including side sticks, center sticks, throttles, cyclics, and collectives, etc.) is measured at high frequency. In some cases, the frequency for measuring the position of the one or more pilot control inceptors may be at least 50 Hz, 100 Hz, 200 Hz, 300 Hz, 400 Hz, or any number in between or greater than 400 Hz. The measurement may be performed for each input channel or each pilot control inceptor.

As shown in FIG. 4, at each measurement, the position of each inceptor is stored in a sliding-window buffer of the last K measurements 405. The size of sliding-window or value of K may be determined based on empirical data or the measurement frequency. For example, K may be at least 3, 4, 5, 6, 7, 8, 9, 10. At any instant, this sliding-window buffer may represent a recent history of the operator input device trajectory in each control channel. Rather than just communicating the current position of the inceptors at each transmission timestep, the CSC may use such recent history or recent operator input device trajectory to predict the future operator input trajectory of each inceptor as a function of time. The choice of buffer length K is important. The buffer length K may be selected to be sufficiently long to identify consistent trends, but not so long as to dampen out rapidly-changing pilot inputs and diminish responsiveness.

In some cases, the method may comprise fitting a polynomial model or rational model (ratio of two polynomial functions) 401 to the previous K measurements 405 to produce the functional approximation. Alternatively, in dynamic-frequency-limited applications, a Fourier basis regression may be used. Each inceptor or input channel may be fit independently. For example, depending on the data characteristics, different input channels may be fit with different regression models and/or the degrees or number of coefficients may be different. In some cases, the coefficients of the approximating curve may be computed by numerical differentiation techniques or least-squares optimization.

In some cases, different regression models such as polynomial model or rational model may be selected based on the type of the input device (e.g., inceptor). In some cases, the input may be limited to a bounded range (for example u(t) in [−1,1]), and a rational curve which asymptotically returns u(t)→0 may be selected over the polynomial model.

In the case of fitting a Fourier series, the maximum representable frequency may be determined from the bandwidth of the control system onboard the vehicle, and by the buffer length K. In some cases, the number of coefficients or Fourier bases may be selected based on the characteristics of the input data. For instance, the number of coefficients (or degrees) or Fourier bases may be selected to be large enough to capture sufficiently-rich trends in the motion (e.g., velocities and accelerations) while not being too large to cause overfitting to the input history. In some cases, the number of coefficients may be determined based on transmission bandwidth. For example, the coefficients are transmitted over the radio link as part of the fitting result to the remote vehicle, and bandwidth capacity may impose further restrictions on the number of coefficients selected.

In some cases, the short-horizon numeric fit 401 may employ explicit least-squares approximation. Because the use of numeric differentiation techniques can be highly sensitive to noise, an explicit least-squares approximation may be preferred. A benefit of explicit optimization-based fitting is the ability to include regularization terms to improve generalization or to include weighting terms which preferentially penalize error at more recent timesteps and allow more error at older timesteps. Following is an example of least-squares polynomial fit that may be utilized as the functional approximation:

$${\sum }_{k = 1}^{K} {r}^{k} {‖ {u}_{- k} - {p}^{T} {β}_{d} ( {t}_{- k} ) ‖}_{2}^{2}$$

Inputs to the optimization problem may include:
{u₋ₖ}: set of K discrete input samples buffer.
r∈[0, 1]: discount factor relaxes fitment penalty on older timesteps (Note that k increments backwards in time).
β_{d}(t)=[t^{d}, t^{d-1}, . . . , t, 1]^{T}: order-d polynomial basis.

Outputs optimal set of coefficients p, such that u⁽¹⁾(t)=p^{T}β_{d}(t) describes an order-d polynomial in t. The output of the first-stage of the method 400 may comprise a numerically-fit input trajectory 411 which may be transmitted to the RVC in command packets.

In general, the CSC may uplink pilot commands to the remote vehicle at a lower rate (e.g., 20 Hz) than the measurement rate of the inceptors (e.g., 400 Hz). This may be motivated by bandwidth limitations of the communication link or by computational limitations in either the CSC or RVC.

### Extending the Prediction Via Explicit Optimal Control-Long-Horizon Prediction

The first stage short-horizon prediction described above is purely numeric, operating on each inceptor channel independently and depending on a recent history of sampled positions. During the short-horizon prediction, the method may not consider vehicle dynamics or operating envelopes, hazards in the proximity of the vehicles, mission objectives, or any other higher-level considerations. The human operator, in contrast, considers all of these latter factors, and is desired be able to communicate their changing intentions to the vehicle in a responsive fashion. Thus, the numeric prediction produced in the first phase may only be trusted for relatively short time horizons, for example, a time period up to 10-100 ms. In contrast, the second stage prediction of the method herein may explicitly consider such higher-level factors and thus can produce a reliable prediction of operator intention for significantly longer horizons (e.g., a time period up to 100 ms to 5 seconds).

The second-stage prediction takes the first-stage prediction 411 as an input, as well as any real-time sensor information 421 that may describe safety hazards or mission objectives 432 in the proximity of the vehicle. In some cases, the second-stage prediction may assume a dynamics model of the vehicle 431. The dynamic model of the vehicle defines how the pilot inputs influence the vehicle's motion. The dynamics model can be produced via first-principles (i.e., from theory) or empirically from data collected on the vehicle. Following is an example of an equation for the expanded time horizon prediction 425:

$${u}^{\text{?}} ( t ) = {arg min}_{\text{?}} {\int }_{0}^{T} \{ {e}^{\text{?}} {\underbrace{{‖ u ( t ) - {u}^{\text{?}} ( t ) ‖}_{2}^{2}}}_{\text{?}} + ( 1 - {e}^{\text{?}} ) {\underbrace{( {‖ x ( t ) - \overline{x} ‖}_{\text{?}}^{\text{?}} + g ( x ( t ) , Z ) )}}_{\text{?}} \} dt + p {‖ x ( T ) - {x}^{\text{?}} ‖}_{\text{?}}^{\text{?}}$$

$$subject to : \dot{x} ( t ) = f ( x ( t ) , u ( t ) )$$

$$x ( 0 ) = {x}_{0}$$

$$\text{?} \text{indicates text missing or illegible when filed}$$

Inputs to the optimization problem may include:
u⁽¹⁾(t) 411: numerically-fit input trajectory produced by stage-one of the algorithm.
x: reference state or trim condition related to safe state objective, e.g., “straight and level” cruise.
T>0: prediction horizon—may be up to or beyond T_{LL}.
τ∈(0, T_{LL}): blending time constant: larger values favor following u⁽¹⁾(t) more closely while smaller values prioritize stability and safety objectives.
Q≥0: penalizes deviation of predicted state trajectory from x.
p≥0: cost penalty on deviation of final x^{(T)}
Z: sensor data describing hazards in the environment
x₀: initial state

The above optimal control algorithm utilizes explicit optimization-based techniques to identify a long-horizon input trajectory over an extended time horizon T and smoothly combines the purely numeric, short-horizon input prediction u⁽¹⁾(t) produced by the first phase of the algorithm with higher-level considerations of safety, stability, and mission objectives 432. Specifically, a “stability” objective 432 can be expressed as a quadratic penalty on deviation from a pre-specified equilibrium state x. For example, the stability objective for an aerial vehicle may represent hover or straight-and-level flight and the reference state or equilibrium state may be straight and level. Hazards and mission objectives may be captured in additional cost terms g(x, Z) which optionally depend on onboard sensor data Z 421. For example, in the specific context of hazard avoidance, these costs may take the form of penalty or barrier functions. In some cases, explicit constraints may also be used, but such explicit constraints may be selected to ensure that either a feasible solution always exists or to specifically handle non-existence.

The optimal control formulation above can be interpreted as blending the prior input estimate u⁽¹⁾(t) with the higher-level objectives according to a blending time constant τ>0. Choosing t large forces the optimized solution u⁽²⁾(t) to remain close to the prior u⁽¹⁾(t), whereas choosing t small gives more preference to the a priori high level objectives. The value of the time constant may be tuned based on empirical test data. Alternatively or additionally, the value of the time constant may be adjusted based on feedback from an operator (e.g., pilot feedback).

The system dynamics model f(x, u) 431 enables the optimization to map input trajectories u(t) to state trajectories x(t). The system dynamic model may be obtained based on theory, constructed using empirical test data, or a combination of both. This dynamics model mirrors the operator's conscious and subconscious expectations of the system's behavior, justifying the idea that the final solution u⁽²⁾(t) can indeed capture operator intent over long time horizons.

Efficient, real-time solution of this optimization problem may be achieved in a number of ways. For example, the exploitation of differential flatness properties or linear dynamics models can be used to avoid explicit enforcement of a nonlinear dynamics constraint. In such cases, and with careful selection of the mission and safety objectives g(x, Z), the overall optimization may reduce to a convex quadratic program. Alternatively, nonlinear optimal control techniques such as differential dynamic programming, successive convexification, or approximate techniques like discrete search may be used. While it is natural to express the problem formulation in continuous-time, in practice standard discrete-time approximations may be used.

The above prediction formulation has several advantages beyond simple intent prediction. It allows hazards detected by onboard sensors to be ultimately avoided even when the operator fails to identify or avoid them him- or herself. Additionally, at the upper-end of the time horizon, the optimal control objective can incentivize a return to stable or safer dynamic conditions (e.g., straight and level flight in the case of aircraft) from which a fully autonomous lost-link mode may more easily take control.

### Execution of Predicted Trajectory

At the RVC, each received packet 411 describes a short horizon input trajectory y₁(t) that is ingested by the model-based optimal control solver 423, producing a long-horizon input trajectory y₂(t) 427. The long-horizon input trajectory 427 may be utilized to control actuator 443 via the existing control laws 441. For example, the controller for the actuators may query the long-horizon input trajectory at a particular time t to generate a control signal for controlling the actuators of the remote vehicle.

To generate a control signal precisely based on the predicted long-horizon input at time t, a scheme for correctly referencing the “start time” of the long-horizon input trajectory in the RVC's clock is required. Time synchronization between the RVC clock and the CSC clock may be required to execute the precise input at time t. The clock offset may be obtained via standard clock synchronization protocols such as Network Time Protocol, or the use of a common reference such as GPS time.

$${t}_{0} = {}^{CSC} {t}_{0} + {d}_{sync} .$$

Furthermore, as illustrated in FIG. 2, real-world communications links typically have a non-zero “baseline” or nominal latency, dₙₒₘ, representing average performance under nominal conditions. To avoid destabilizing feedback loops, the method herein may correct the fundamental communication latency by delaying the reference time accordingly. In some cases, the RCV may compute the query time as following:

$$t = {t}_{n o w} - ( {t}_{0} + {d}_{delay} )$$

where t_{now} represents the RCV wall time (generated by RCV clock), to the trajectory generation time in the RCV clock frame, and d_{delay}>=dₙₒₘ is added to offset the nominal latency.

Under good connection conditions, packets are received without drops and with latency very close to dₙₒₘ. In this case, the inputs extracted from y₂(t) may be very close to the numeric approximation y₁(t) and ultimately to the non-predictive operator input y(0). During a momentary dropout, the system may query the trajectory further from t₀, and the inputs extracted from y₂(t) will be biased more heavily towards the safety and mission objectives embedded in the model predictive optimization. If the dropout persists towards T_{LL}, the queried inputs will guide the system naturally towards a stable and safe configuration from which the lost-link protocol can be entered with minimal disruption.

FIG. 4 shows a system implementing the remote control methods consistent with those described herein. For each input channel, the CSC samples inceptor position at a high rate, populating a sliding-window buffer. This recent data is used to perform a short-horizon functional approximation, the coefficients of which are sent over the communications link to the RVC. The RVC combines the short-horizon input trajectory with onboard sensor data via Model-Predictive Optimal Control to produce a long-horizon input trajectory prediction capturing implied pilot intent.

Vehicle Degrees of Freedom. The vehicle may be capable of moving freely within the environment with respect to six degrees of freedom (e.g., three degrees of freedom in translation and three degrees of freedom in rotation). Alternatively, the movement of the vehicle may be constrained with respect to one or more degrees of freedom, such as by a predetermined path, track, or orientation. The movement can be actuated by any suitable actuation mechanism, such as an engine or a motor. The actuation mechanism of the vehicle can be powered by any suitable energy source, such as chemical energy, electrical energy, magnetic energy, solar energy, wind energy, gravitational energy, nuclear energy, or any suitable combination thereof. The vehicle may be self-propelled via a propulsion system, as described elsewhere herein. The propulsion system may optionally run on an energy source, such as electrical energy, magnetic energy, solar energy, wind energy, gravitational energy, chemical energy, nuclear energy, or any suitable combination thereof.

Examples of Vehicles. Systems herein may be used to remote control any type of vehicles which may include water vehicles, aerial vehicles, space vehicles, or ground vehicles. For example, aerial vehicles may be fixed-wing aircraft (e.g., airplane, gliders), rotary-wing aircraft (e.g., helicopters, multirotors, quadrotors, and gyrocopters), aircraft having both fixed wings and rotary wings (e.g. compound helicopters, tilt-wings, transition aircraft, lift-and-cruise aircraft), or aircraft having neither (e.g., blimps, hot air balloons). A vehicle can be self-propelled, such as self-propelled through the air, on or in water, in space, or on or under the ground. A self-propelled vehicle can utilize a propulsion system, such as a propulsion system including one or more engines, motors, wheels, axles, magnets, rotors, propellers, blades, nozzles, or any suitable combination thereof. In some instances, the propulsion system can be used to enable the movable object to take off from a surface, land on a surface, maintain its current position and/or orientation (e.g., hover), change orientation, and/or change position.

Vehicle Size and Dimensions. The vehicle can have any suitable size and/or dimensions. In some embodiments, the movable object may be of a size and/or dimensions to have a human occupant within or on the vehicle. Alternatively, the vehicle may be of size and/or dimensions smaller than that capable of having a human occupant within or on the vehicle. The vehicle may be of a size and/or dimensions suitable for being lifted or carried by a human. Alternatively, the vehicle may be larger than a size and/or dimensions suitable for being lifted or carried by a human.

Vehicle Propulsion. The propulsion mechanisms can include one or more of rotors, propellers, blades, engines, motors, wheels, axles, magnets, or nozzles, based on the specific type of vehicle. The propulsion mechanisms can enable the vehicle to take off vertically from a surface or land vertically on a surface without requiring any horizontal movement of the vehicle (e.g., without traveling down a runway). Optionally, the propulsion mechanisms can be operable to permit the vehicle to hover in the air at a specified position and/or orientation.

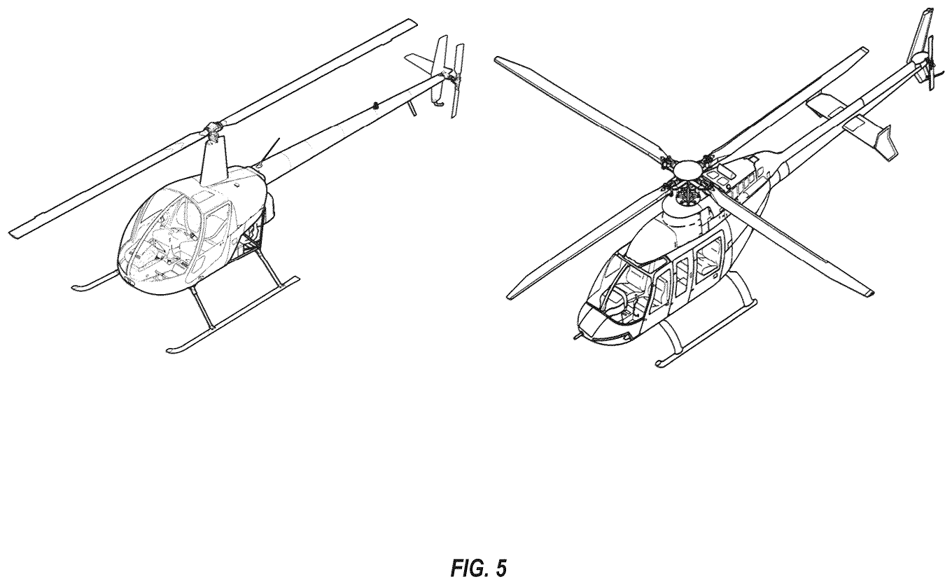

Aircraft Vehicle. In some embodiments, the vehicle may be a vertical takeoff and landing aircraft or helicopter. FIG. 5 shows examples of aircraft controlled by the methods and systems herein. In some cases, the aircraft may be powered by liquid hydrocarbon fuel. In some cases, the aircraft may comprise a single-single architecture or two-engine architecture. In some cases, the aircraft may comprise a swashplate-based rotor control system that translates input via the helicopter flight controls into motion of the main rotor blades. The swashplate may be used to transmit the pilot's commands from the non-rotating fuselage to the rotating rotor hub and main blades. Although the vehicle is depicted as an aircraft, this depiction is not intended to be limiting, and any suitable type of movable object can be used, as described elsewhere herein. One of skill in the art would appreciate that any of the embodiments described herein in the context of aircraft systems can be applied to any suitable movable object (e.g., a spacecraft, naval, or ground craft).

Types of Real-time Input. Referring back to FIG. 1, a vehicle may have Real-time Inputs (IN1). The Real-time Inputs may comprise information streams that vary with time depending on the state of the vehicle, its position, and its surroundings, as well as other time-dependent factors. In some embodiments, the Real-time Inputs may comprise Indirect Real-time Inputs (IN1a/IN1d), Direct Real-time Inputs (IN1b/IN1e), and/or Vehicle State Real-time Inputs (IN1c/IN1f). All of these real-time inputs that are sensed or received by the aircraft that are then transmitted to the Pilot may be collectively referred to as “telemetry”.

Indirect Real-time Inputs. A vehicle may have Indirect Real-time Inputs (IN1a/IN1d). The Indirect Real-time Inputs may comprise information streams that are received by the vehicle and may not comprise direct sensor observation data or measurement data of the vehicle. The Indirect Real-time Inputs may include, for example, peer-to-peer broadcast of information streams or communications that are received by the vehicle. Such Indirect Real-time Inputs may not be received by the RCS. In some cases, the Indirect Real-time Inputs may include ADS-B, wireless communications with parties other than the RCS such as analog voice communications, digital voice communications, digital RF communications, MADL, MIDS, and Link 16. The Indirect Real-time Inputs by default may not be transmitted to the RCS or may be transmitted to the RCS on-demand. For example, the Indirect Real-time Inputs may be transmitted to the RCS upon a request when the RCS cannot receive the inputs from another party (e.g. if the RCS out of range of two-way radio communications with a third-party control tower while the vehicle is not). Alternatively, Indirect Real-time Inputs may not be transmitted to the RCS when the information is only needed for processing and decision-making onboard the vehicle itself (e.g. using ADS-B data to support an onboard detect and avoid system).

Direct Real-time Inputs. A vehicle may have Direct Real-time Inputs (IN1b/IN1e). The Direct Real-time Inputs may comprise information streams that are directly observed or measured by the vehicle (e.g., sensors onboarding the vehicle, sensors offboarding the vehicle) about its environment and surroundings. Some examples of types of sensors that provide Direct Real-time Inputs may include location sensors (e.g., global positioning system (GPS) sensors, mobile device transmitters enabling location triangulation), vision sensors (e.g., imaging devices capable of detecting visible, infrared, or ultraviolet light, such as cameras), proximity or range sensors (e.g., ultrasonic sensors, lidar, time-of-flight or depth cameras), altitude sensors, attitude sensors (e.g., compasses), pressure sensors (e.g., barometers), temperature sensors, humidity sensors, audio sensors (e.g., microphones), and/or field sensors (e.g., magnetometers, electromagnetic sensors, radio sensors) and various others.

Direct Real-time Inputs: Multi-camera. The Direct Real-time Inputs may comprise data captured by one or more imaging devices (e.g., camera). The imaging devices may comprise one or more cameras configured to capture multiple image views simultaneously. For example, the one or more imaging devices may comprise a first imaging device and a second imaging device disposed at different locations onboard the vehicle relative to each other such that the first imaging device and the second imaging device have different optical axes.

Direct Real-time Inputs: Camera Stitching. In some embodiments, video streams from onboard cameras may be combined together allowing for a greater field of view than a single camera. For instance, the video streams transmitted to the remote control station may be used to construct a 720 degree surround image to a pilot without obstruction. For instance, the camera may be pointed below the vehicle such that the pilot may be able to view underneath her feet without obstruction.

Vehicle State Real-time Inputs. The vehicle may have Vehicle State Real-time Inputs (IN1c/IN1f), which are information streams that are related to the Vehicle's own state. Some examples of types of sensors that provide Vehicle State Real-time Inputs may include inertial sensors (e.g., accelerometers, gyroscopes, and/or gravity detection sensors, which may form inertial measurement units (IMUs)), temperature sensors, magnetometers, Global Navigation Satellite System (GNSS) receivers, fluid level and pressure sensors, fuel sensors (e.g., fuel flow rate, fuel volume), vibration sensors, force sensors (e.g., strain gauges, torque sensors), component health monitoring sensors (e.g., metal chip detectors), microswitches, encoders, angle and position sensors, status indicators (e.g., light on/off) and various others that can help determine the state of the vehicle and its components. This is separate to the Direct Real-time Inputs which provide situational awareness of the vehicle's surroundings (although there is of course an inevitable coupling and overlap between the two).

Communications Gateway. The Communications Gateway provides a reliable wireless communications channel with sufficient bandwidth and minimal latency to transmit data from Vehicle Real-time Inputs or data that has been processed by the Onboard Preprocessing Computer. Depending on the application and the physical distance between remote operator and aircraft, the channel may be a direct line-of-sight or beyond line-of-sight point-to-point electromagnetic communications channel or employ a more complex communications scheme reliant on a network of ground- or satellite-based nodes and relays. It may also use the internet as an intermediate network. The Communications Gateway may comprise physical communications channels that have different bandwidth, latency, and reliability characteristics, such as RF link, Wi-Fi link, Bluetooth link, 3G, 4G, 5G link. The communications channels may employ any frequency in the electromagnetic spectrum either analog or digital, and may use spread spectrum and frequency hopping. The Gateway may switch automatically between these channels according to their availability and performance and may negotiate with the Onboard Preprocessing Computer to determine the priority of data to send and the types of data to send.

Communications Downlink. The data transmitted via the downlink from the vehicle to the RCS may depend on the state and location of the vehicle, the mission requirements, the operating mode, the availability and performance of communications channels, and the type and location of the RCS. For example, based on the availability and performance of the communication channels (bandwidth, range), a subset of the Real-time Inputs may be selected and processed by the Onboard Preprocessing Computer and may be transmitted via the downlink to the RCS for pilot situational awareness, control, telemetry, or payload data.

Communications Uplink. The data transmitted via the uplink from the ground control station (GCS) may depend on the state and location of the vehicle, the mission requirements, the operating mode, the availability and performance of communications channels, and the type and location of the RCS. The data may comprise control inputs from the pilot, payload data, software updates, and any other information that is required by the Onboard Control Computer. Control inputs from the pilot can include the pitch, roll, yaw, throttle, and lift inputs which control the digital actuators on the aircraft as well as digital toggles for controls such as lights, landing gear, radio channels, camera views, and any other pilot controlled aircraft settings.

Vehicle Digital Control, Actuation, and Information Transmission System. The system comprises a framework for delivering outputs onboard the vehicle through actuators and transmitters. This includes fly-by-wire or drive-by-wire actuation of vehicle control surfaces that uses digital signals to drive electro-mechanical, electro-hydraulic, and other digital actuators (“Onboard Vehicle Outputs”). The outputs of the vehicle can also include “Direct Vehicle Outputs”, which generally correspond to mission and application equipment, e.g., payload delivery systems for cargo transport, water delivery systems for firefighting, and agricultural spray systems. Various Direct Vehicle Outputs may also be related to features for the carriage of passengers, such as environmental control systems, ejection systems, and passenger transfer systems. The outputs of the vehicle can also include “Indirect Vehicle Outputs”, which may include the transmission of voice data to air traffic control, or other broadcast or point-to-point information transmission to third parties.

Fly-by-wire Aircraft Actuation. In some embodiments, the vehicle may be an aircraft and may comprise a fly-by-wire actuation of vehicle control surfaces. The fly-by-wire systems may interpret the pilot's control inputs as a desired outcome and calculate the control surface positions required to achieve that outcome. For example, applying left rotation to an airplane yoke may signal that the pilot wants to turn left. In order for the aircraft to perform a proper, coordinated turn while maintaining speed and altitude, the rudder, elevators, and ailerons are controlled in response to the control signal using a closed feedback loop.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. Numerous different combinations of embodiments described herein are possible, and such combinations are considered part of the present disclosure. In addition, all features discussed in connection with any one embodiment herein can be readily adapted for use in other embodiments herein. It is intended that the following claims define the scope of the invention and that methods and structures within the scope of these claims and their equivalents be covered thereby.

What is claimed is:

1. A computer-implemented method for predicting an operator's intent for controlling a remote vehicle, the method comprising:
(a) predicting a first intent over a short horizon based on an input device position data, wherein the first intent is predicted by performing a numeric fit to K number of input device position data samples and wherein the K number of input device position data samples are collected from an input control device for controlling the remote vehicle;
(b) predicting a second intent over a long horizon based at least in part on the first intent predicted in (a) and real-time sensor data, wherein the real-time sensor data are collected from one or more sensors onboard the remote vehicle; and
(c) generating a control signal for controlling one or more actuators of the remote vehicle based on the second intent.

2. The computer-implemented method of claim 1, wherein operation (a) is performed by one or more processors located at a remote control station.

3. The computer-implemented method of claim 1, wherein the first intent comprises a numerically-fit trajectory of the input device position data.

4. The computer-implemented method of claim 3, further comprising transmitting the numerically-fit trajectory of the input device position data to the remote vehicle via a wireless link.

5. The computer-implemented method of claim 4, wherein a regression model for performing the numeric fit is selected based at least in part on a bandwidth of the wireless link.

6. The computer-implemented method of claim 1, wherein operation (b) is performed by one or more processors onboard the remote vehicle.

7. The computer-implemented method of claim 1, wherein the second intent is further predicted based on a dynamic model of the remote vehicle.

8. The computer-implemented method of claim 1, wherein the real-time sensor data are used for hazard avoidance.

9. The computer-implemented method of claim 1, wherein the second intent is predicted using an explicit optimization-based algorithm.

10. The computer-implemented method of claim 9, wherein the second intent is further predicted based on a predefined safety objective of the remote vehicle.

11. The computer-implemented method of claim 10, wherein the predefined safety objective of the remote vehicle is represented by a deviation between a current state and a reference state.

12. The computer-implemented method of claim 11, wherein the current state is measured by the real-time sensor data.

13. The computer-implemented method of claim 10, wherein the explicit optimization-based algorithm comprises a blending time constant for blending the first intent with the predefined safety objective.

14. The computer-implemented method of claim 1, wherein the second intent comprises a long-horizon input trajectory and the control signal is generated based on the long-horizon input trajectory.

15. The computer-implemented method of claim 14, wherein the long-horizon input trajectory is executed by a controller onboard the remote vehicle by synchronizing a clock of the remote vehicle and a clock at the input control device.

16. A system for predicting an operator's intent for controlling a remote vehicle, the system comprising:
(a) a first processor programmed to predict a first intent over a short horizon based on an input device position data, wherein the input device position data are collected from an input control device for controlling the remote vehicle and wherein the first processor is located at a control station;
(b) a second processor programmed to i) predict a second intent over a long horizon based at least in part on the first intent and real-time sensor data, and ii) generate a control signal for controlling one or more actuators of the remote vehicle based on the second intent, wherein the real-time sensor data are collected from one or more sensors onboard the remote vehicle and wherein the second progressor is located at the remote vehicle.

17. The system of claim 16, wherein the first intent is predicted by performing a numeric fit to K number of input device position data samples.

18. The system of claim 17, wherein the first intent comprises a numerically-fit trajectory of the input device position data.

19. The system of claim 17, wherein a regression model for performing the numeric fit is selected based at least in part on a bandwidth of a wireless link between the control station and the remote vehicle.

20. The system of claim 16, wherein the second intent is further predicted based on a dynamic model of the remote vehicle.
